(19) United States
(12) Patent Application Publication
(10) Pub. No.: US 2013/0114816 A1
(43) Pub. Date: May 9, 2013

(54) Audio Coupling System

(71) Applicants: Noel Lee, Las Vegas, NV (US); David Leung, San Mateo, CA (US)

(72) Inventors: Noel Lee, Las Vegas, NV (US); David Leung, San Mateo, CA (US)

(21) Appl. No.: 13/640,299

(22) PCT Filed: Jan. 3, 2011
(86) PCT No.: PCT/US11/20057

§ 371 Date: Jan. 9, 2013

Related U.S. Application Data
(60) Provisional application No. 61/292,132, filed on Jan. 4, 2010.

(51) Int. Cl. H04R 1/10; H04R 5/04

(52) U.S. Cl. CPC H04R 1/1033; H04R 5/04
USPC 381/1; 381/74

(57) ABSTRACT

A device for the sharing audio signals. A pair of headphones includes circuitry for connecting to an audio signal input, as is typical, but also for connecting to an audio signal output. The audio output allows a plurality of personal listening devices, for example headphones, to be linked together allowing a plurality of listeners to listen to the same audio signal, yet maintain the utility provided by a headphone listening system

The present application claims the priority of U.S. Provisional Patent Application Ser. No. 61/292,132 filed Jan. 4, 2010, which application is incorporated in its entirety herein by reference.

### TECHNICAL FIELD

The present invention relates to the field of audio listening devices. More particularly, the present invention relates to a system and method for coupling one or more audio listening devices.

### BACKGROUND ART

Audio listening and audio signal generating devices are well known in the art. Since the creation of audio signal generating devices, listeners have continued to increasingly demand new and improved ways to enjoy listening to audio signals. Listening to audio signals, is an activity frequently enjoyed by a group of listeners. Typically there are two standard ways to listen to audio, loudspeakers and personal listening devices. Listeners often employ loudspeakers suitable for generating the audio signals throughout a larger area, such as a room, allowing a group to listen to the audio signals.

Listeners may employ the personal listening devices, such as headphones, earbuds, or similar devices, which are adapted to place a sound generating device near the listeners' ear. These personal listening devices typically limit the generated sound to one listener. Limiting the generated sound to one listener has many benefits, for example, in public areas the listener may listen to the audio of their choice without interfering with others. However, a group of listeners may desire to listen to the audio signal provided by a single audio signal generating device. In these situations, the listeners may also require the utility provided by personal listening devices.

Some have attempted to solve this problem by providing an audio signal splitter device. Known for quite some time, these devices typically take one audio signal and duplicate it, allowing two devices to receive the audio signal. These devices, to cooperate with typical audio signal generation devices, have one male audio signal connector (e.g., stereo plug) which connects with the audio signal generation device to receive the audio signals. The audio signal is then electrically split and provided to two female audio signal connectors, typically disposed near the male audio signal connector. Two personal listening devices may then be connected to the splitter to receive the shared audio signal. Unfortunately, such connections often result in multiple cables which may become tangled, and when three or more listeners desire to listen to the audio signal from a single audio signal generation device, the signals may become unbalanced and depending on the impedance of the personal listening devices, sound quality may be degraded. A connection resulting in very low impedance, may also damage the audio signal generation device.

### SUMMARY OF THE INVENTION

The present invention addresses the above and other needs by providing a device for the sharing audio signals. A pair of headphones includes circuitry for connecting to an audio signal input, as is typical, but also for connecting to an audio signal output. The audio output allows a plurality of personal listening devices, for example headphones, to be linked together allowing a plurality of listeners to listen to the same audio signal, yet maintain the utility provided by a headphone listening system.

Accordingly, herein disclosed is a new approach to coupling, or sharing, audio signals. In an embodiment of the invention, a pair of headphones' circuitry is integrated with an audio input, as is typical, but also an audio output.

This addition of an audio output allows a plurality of audio listening devices, in this case headphones, to be linked together where, thereby, a plurality of listeners may experience the same audio signal while maintaining the utility provided by using headphones and similar devices.

### BRIEF DESCRIPTION OF THE DRAWING

The above and other aspects, features and advantages of the present invention will be more apparent from the following more particular description thereof, presented in conjunction with the following drawings wherein:

FIG. 1 shows personal listening devices according to the present invention connected for multiple listeners.

FIG. 2A is a front view of the personal listening device according to the present invention.

FIG. 2B is a top view of the personal listening device according to the present invention.

FIG. 2C is a bottom view of the personal listening device according to the present invention.

FIG. 3 shows circuitry of the personal listening device according to the present invention.

FIG. 4 shows circuitry of an earbud style personal listening device according to the present invention.

Corresponding reference characters indicate corresponding components throughout the several views of the drawings.

### BEST MODES FOR CARRYING OUT THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

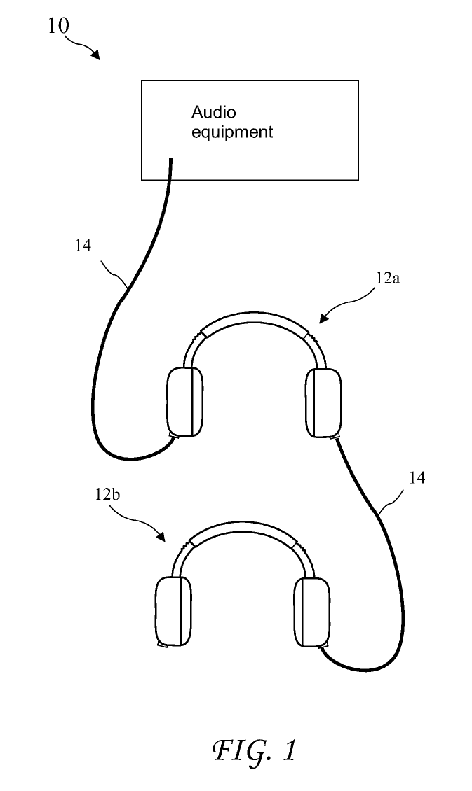

Personal listening devices 12 according to the present invention are shown connected for multiple listeners in FIG. 1. Audio equipment 10 generates an electrical audio signal. Examples of the audio equipment 10 include portable music player, personal devices such as an iPOD® made by Apple Inc., CD players, tape players, tuners, and the like. Such audio equipment generally includes a female stereo plug for receiving a male plug commonly called a Tip, Ring, Sleeve (TRS) connector. Both full size and miniature TRS connectors are well known in the art. The tip generally carries the left-hand stereo signal, the ring generally carries the right-hand stereo signal, and the sleeve is generally ground.

A stereo cable 14 is electrically connected to the audio equipment 10 to receive the electrical audio signal and also connected to a first personal listening device 12a to carry the electrical audio signal to the personal listening device 12a. A second stereo cable 14 is connected to the personal listening device 12a to carry the electrical audio signal to a second personal listening device 12b. Each personal listening device 12a and 12b includes electrical circuitry to both generate an audio signal for a listener wearing the personal listening device 12a or 12b, and to also allow connecting the stereo cable 14 to carry the electrical audio signal to another personal listening device 12a or 12b for a second listener. Similarly, plurality of personal listening devices 12 may be chained together allowing large numbers of listeners to access the same audio signal.

The connectivity provided by the personal listening device 12 provides a potential reduction of cable material. Similarly, the connectivity provided by the personal listening device 12 allows for improved cable management, eliminating much of the juxtaposition of cables when each personal listening device 12 is independently connected to the Audio equipment 10. Many uses for audio listening devices, such as the personal listening device 12, occur in restricted environments with potentially many people and other hazards, for example at music clubs, discos, DJ Booths, or other areas where music provides a function. The narrowing of potentially interfering cables, especially cables disposing from audio generating devices, is of potential importance. As another example of the many further benefits, the disposition allows for listeners to become increasingly further from the audio generating device.

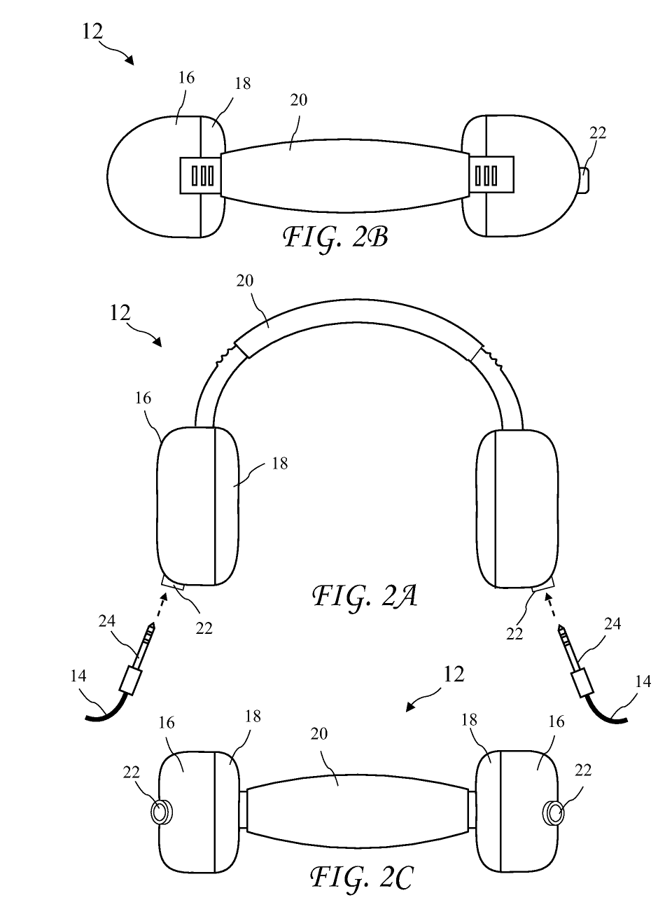

A front view of the personal listening device 12 according to the present invention is shown in FIG. 2A, a top view of the personal listening device 12 is shown in FIG. 2B, and a bottom view of the personal listening device 12 is shown in FIG. 2C. The personal listening device 12 includes ear pieces 16, soft cushions 18, and head piece 20. The personal listening device 12 further includes two female connectors 22 for receiving stereo plugs 24 on the cables 14. Each personal listening device 12 may thus be electrically connected to the audio equipment 10 and to another personal listening device 12, or electrically connected to two personal listening devices 12 to share an electrical audio signal. While two female connectors 22 are shown on each personal listening device 12, in another embodiment a personal listening device may include a stereo cable permanently electrically connected to the personal listening device and a single female connector 22. In still another embodiment, a personal listening device may include a combination of two or more female connectors 22 and a stereo cable 14, or three or more female connectors 22.

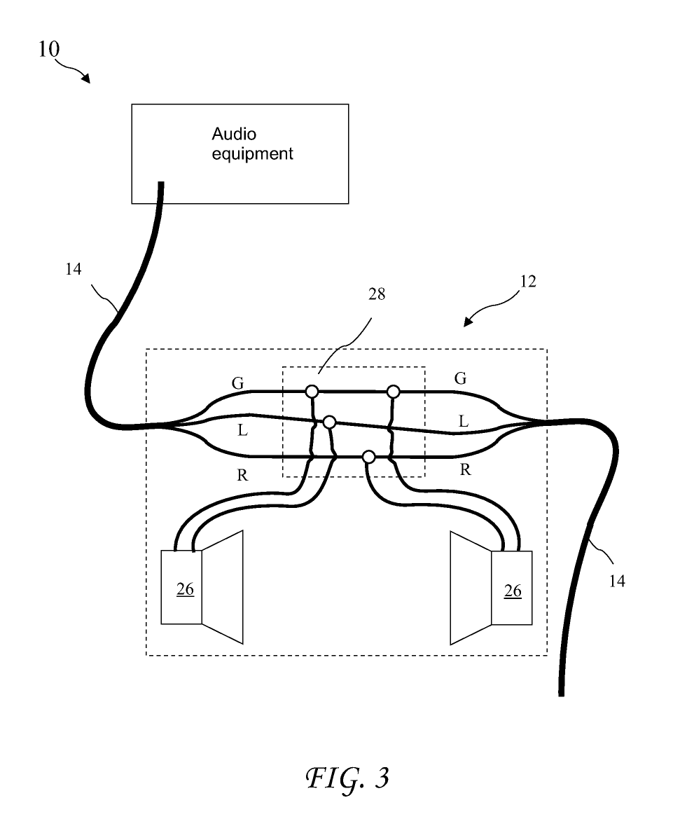

Circuitry 28 of the personal listening device 12 according to the present invention, comprising headphones, is shown in FIG. 3. The circuitry 28 is connected between the female connectors 22. The example shown in FIG. 3, audio transducers (or speakers) 26 in the ear pieces 16 are in a simple parallel electrical connection with the stereo cables 14. In other examples, the speakers 26 may be wired in series with the stereo cables 14. In still other examples, the circuit 28 may provide additional features, such as sensing the impedance in the connected personal listening devices 12 and configuring the electrical connection of the speakers 26 to the stereo cables 14 to provide a minimum impedance or an optimal impedance.

Moreover, the circuitry 28 of the personal listening device 12 may include signal processing and/or signal filtering, as well known in the art, to improve the signal. This improved signal may then be provided to another connected personal listening device 12.

The circuitry 28 may further provide amplification, as well known in the art, to amplify the signal for the personal listening device 12 or for amplifying the electrical audio signal for an additional connected personal listening devices 12.

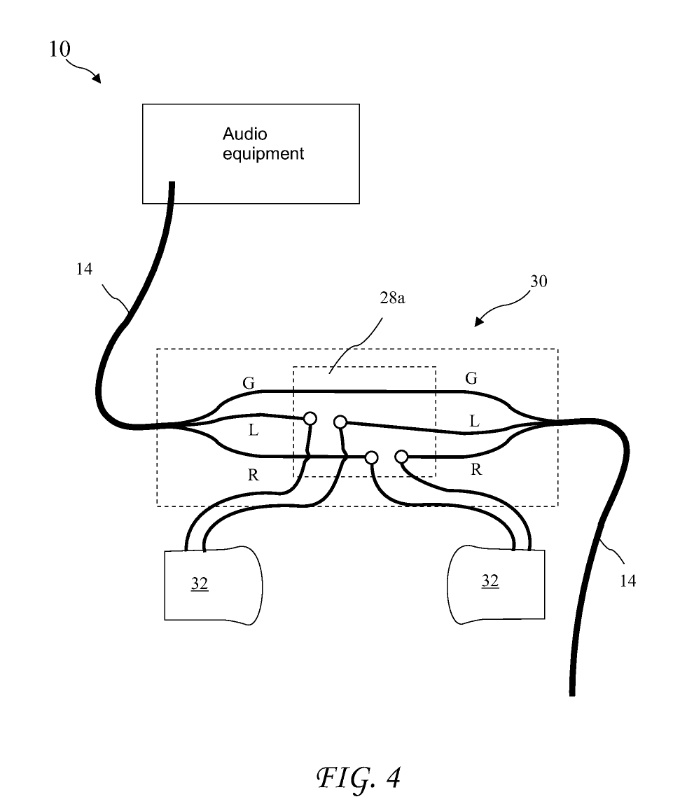

A circuitry 28a of an earbud style personal listening device 30 is shown connected in series in FIG. 4. The personal listening device 30 includes the same function as the personal listening device 12, but provides the electrical audio signals to left and right earbuds 32 including acoustic transducers 26 (see FIG. 3). Connecting the transduces in series results in higher impedance than the parallel connection in FIG. 3.

Information as herein shown and described in detail is fully capable of attaining the above-described object of the invention, and is, thus, representative of the subject matter which is broadly contemplated by the present invention. The scope of the present invention fully encompasses other embodiments which may become obvious to those skilled in the art, and is to be limited, accordingly, by nothing other than the appended claims, in which reference to an element in the singular is not intended to mean “one and only one” unless explicitly so stated, but rather “one or more.”

All structural and functional equivalents to and combinations of the elements of the above-described preferred embodiment and additional embodiments that are known to those of ordinary skill in the art are hereby expressly incorporated by reference and are intended to be encompassed by the present claims. However, it should be readily apparent to those of ordinary skill in the art that various changes and modifications in form, apparatus material, and fabrication material detail may be made without departing from the spirit and scope of the invention as set forth in the appended claims.

Moreover, no requirement exists for a device or method to address each and every problem sought to be resolved by the present invention, for such to be encompassed by the present claims. Further, no element, component, or method step in the present disclosure is intended to be dedicated to the public regardless of whether the element, component, or method step is explicitly recited in the claims. No claim herein is to be construed under the provisions of 35 U.S.C. §112, sixth paragraph, unless the element is expressly recited using the phrase “means for.”

### INDUSTRIAL APPLICABILITY

The present invention is industrially applicable to audio listening devices.

While the invention herein disclosed has been described by means of specific embodiments and applications thereof, numerous modifications and variations could be made thereto by those skilled in the art without departing from the scope of the invention set forth in the claims.

1. An audio listening device comprising:
a personal listening device electrically connectable to audio equipment by a cable to receive an electrical audio signal;
circuitry electrically connected to the personal listening device to provide said electrical audio signal to one or more audio transducers connected to the personal listening device; and
a connector attached to the personal listening device and electrically connected to the circuitry to receive the electrical audio signal and allow connection of a second cable, the second cable receiving the electrical audio signal.

2. The audio listening device of claim 1, wherein a second personal listening device is connected to the second cable to receive the electrical audio signal.

3. The audio listening device of claim 1, wherein the circuitry connects the audio transducers in parallel with the electrical audio signal.

4. The audio listening device of claim 1, wherein the circuitry connects the audio transducers in series with the electrical audio signal.

5. The audio listening device of claim 1, wherein the circuitry filters the electrical audio signal.

6. The audio listening device of claim 1, wherein the circuitry amplifies the electrical audio signal.

7. The audio listening device of claim 1, wherein the personal listening device is a pair of headphones.

8. The audio listening device of claim 1, wherein the headphones include two connectors for detachably connecting stereo cables to the headphones.

9. The audio listening device of claim 8, wherein the two connectors are female connectors.

10. The audio listening device of claim 1, wherein the headphones include one permanently attached stereo cable and one female connector for detachably connecting stereo cables to the headphones.

11. The audio listening device of claim 1, wherein the personal listening device includes a pair of earbuds electrically connected to the circuitry.

12. A method for coupling audio listening devices comprising:
connecting a stereo cable between audio equipment and a first personal listening device;
connecting a second stereo cable between the first personal listening device and a second personal listening device;
generating an electrical audio signal in the audio equipment;
carrying the electrical audio signal from the audio equipment to first circuitry in the first personal listening device over the first stereo cable;
providing the electrical audio signal from the first circuitry to audio transducers attached to the first personal listening device;
carrying the electrical audio signal from the first personal listening device to second circuitry in the second personal listening device over the second stereo cables; and
providing the electrical audio signal from the second circuitry to audio transducers attached to the second personal listening device.

13. The method of claim 12, wherein the personal listening devices are headphones.

14. The method of claim 12, wherein the first stereo cable is permanently attached to the first personal listening device.

15. The method of claim 12, further including filtering the electrical audio signal in the first circuitry to improve the quality of the electrical audio signal.

16. The method of claim 12, further including amplifying the electrical audio signal in the first circuitry.

17. The method of claim 12, further including:
measuring the impedance of the connected personal listening devices in the first circuitry; and
electrically connecting the transducers to the electrical audio signal based on the measured impedance, to optimize operation.

18. An audio listening system comprising:
audio equipment generating an electrical audio signal;
a first stereo cable electrically connected to the audio equipment and receiving the electrical audio signal from the audio equipment;
a first personal listening device comprising:
a first female input connector attached to the first personal listening device, the first stereo cable plugged into the first female input connector, and the first female input connector receiving the electrical audio signal from the first stereo cable;
first circuitry residing in the first personal listening device and electrically connected to the first female input connector and receiving the electrical audio signal from the first female input connector;
first left and right acoustic transducers attached to the first personal listening device and electrically connected to the first circuitry and receiving the electrical audio signal from the first circuitry and generating acoustic signals for a first listener; and
a first female output connector attached to the first personal listening device and electrically connected to the circuitry and receiving the electrical audio signal from the circuitry;
a second stereo cable plugged into the first female output connector and receiving the electrical audio signal from the first female output connector;
a second personal listening device comprising:
a second female input connector attached to the second personal listening device, the second stereo cable plugged into the second female input connector, and the second female input connector receiving the electrical audio signal from the second stereo cable;
second circuitry residing in the second personal listening device and electrically connected to the second female input connector and receiving the electrical audio signal from the second female input connector;
second left and right acoustic transducers attached to the second personal listening device and electrically connected to the second circuitry and receiving the electrical audio signal from the second circuitry and generating acoustic signals for a second listener; and
a second female output connector attached to the second personal listening device and electrically connected to the circuitry and receiving the electrical audio signal from the circuitry.
